(19) United States
(12) Patent Application Publication
(10) Pub. No.: US 2013/0173593 A1
(43) Pub. Date: Jul. 4, 2013

(54) BREADCRUMB FILTERING

(71) Applicants: Gregory M. Nations, Minneapolis, MN (US); Chad R. Gourley, Elk River, MN (US); Michael F. Gonsalves, Minneapolis, MN (US); Troy Neidermire, Minneapolis, MN (US)

(72) Inventors: Gregory M. Nations, Minneapolis, MN (US); Chad R. Gourley, Elk River, MN (US); Michael F. Gonsalves, Minneapolis, MN (US); Troy Neidermire, Minneapolis, MN (US)

(73) Assignee: TARGET BRANDS, INC., Minneapolis, MN (US)

(21) Appl. No.: 13/339,190

(22) Filed: Dec. 28, 2011

(51) Int. Cl. G06F 17/30

(52) U.S. Cl. 707/722; 707/E17.014

(57) ABSTRACT

A first search result page is displayed and includes a plurality of items and a hierarchical list of categories. The hierarchical list of categories is such that each of the plurality of items falls within all of the categories in the hierarchical list of categories. The plurality of items includes only items that match a search criteria entered in a search box. An indication that a category in the hierarchical list of categories has been selected is received. In response, a second search result page is displayed and includes a second plurality of items that fall within the selected category. The second plurality of items includes only items that match the search criteria. At least one item of the second plurality of items was not displayed in the first search result page.

### BACKGROUND

“Breadcrumbs” are graphical elements that are used in computer applications to indicate a user's current location within a system. In particular, when a user is traversing a collection of items that have been grouped into a hierarchy, the breadcrumb indicates the user's location within the hierarchy. Typically, the breadcrumb is displayed with the root of the hierarchy on the far left, the immediate child category of the root category to the right of the root category and further sub categories extending out to the right. Thus, if the user has traversed through five levels of the hierarchy, five separate categories will be displayed in the breadcrumb.

Most breadcrumbs are selectable such that the user can return to any category in the breadcrumb by simply selecting on the category. The displayed web page then reverts to the web page for the selected category and the breadcrumb is shortened so that it ends at the selected category.

The discussion above is merely provided for general background information and is not intended to be used as an aid in determining the scope of the claimed subject matter. The claimed subject matter is not limited to implementations that solve any or all disadvantages noted in the background.

### SUMMARY

A first search result page is displayed and includes a plurality of items and a hierarchical list of categories. The hierarchical list of categories is such that each of the plurality of items falls within all of the categories in the hierarchical list of categories. Only items that match a search criteria entered in a search box are in the plurality of items. An indication that a category in the hierarchical list of categories has been selected is received. In response, a second search result page is displayed and includes a second plurality of items that fall within the selected category. The second plurality of items includes only items that match the search criteria. At least one item of the second plurality of items was not displayed in the first search result page.

An indication that a guest has selected a category in a displayed breadcrumb trail is received. A processor determines whether the displayed breadcrumb trail was displayed on a page providing results of a search query. If the breadcrumb trail was not displayed on a page providing results of a search query, items that fall within the selected category are displayed without reference to a search query. If the breadcrumb trail was displayed on a page providing results of a search query, only items that fall within the selected category and that satisfy the search query are displayed.

A processor serves web pages to a client. A first web page is served to the client that includes instructions to display a chain of categories and items that satisfy a search query and that are categorized in a smallest category in the chain of categories. A request for a second web page is received, where the request for the second web page is generated in response to the selection of a category in the chain of categories. Items that satisfy the search query and that are categorized within the selected category are identified. The second web page is then served to the client. The second web page includes instructions to display a chain of categories that ends with the selected category and to display items that satisfy the search query and that are categorized in the selected category.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method in accordance with one embodiment.

FIG. 2 is an example of a web page providing a search box.

FIG. 3 is an example of a web page providing search results.

FIG. 4 is an example of a portion of a category hierarchy.

FIG. 5 is an example of a search results web page.

FIG. 6 is an example of a search results web page.

FIG. 7 is an example of a search results web page.

FIG. 8 is an example of a category web page.

FIG. 9 is an example of a category web page.

FIG. 10 is a client server network environment.

FIG. 11 is a block diagram of a computing device that may be used in accordance with the various embodiments.

### DETAILED DESCRIPTION

In accordance with the present innovations, a breadcrumb (also referred to as a breadcrumb trail) is provided that behaves differently in a search results page than in other pages such as a category page. A search result page displays items that meet a search query or criterion and that are categorized within a category listed at the end of a breadcrumb. A category page displays items that are categorized within a category listed at the end of a breadcrumb without reference to a search query.

On both the search result page and a category page, a breadcrumb provides a path through a category hierarchy that includes multiple levels or tiers of categories. The breadcrumb lists a chain of categories along the path from the root category to the lowest level category that the current displayed items are found within. Thus, the breadcrumb provides a hierarchical list of categories. When a user selects a category in the breadcrumb, the web page is altered to change the breadcrumb so that it ends at the selected category and to display items that fall within the selected category.

Under the present innovation, selecting a category in a breadcrumb on a search result page returns different items than selecting the same category in the same breadcrumb on a category page. In particular, selecting a category in a breadcrumb on a search result page causes items that are within the selected category and that satisfy the search query or criterion to be returned. Selecting the same category in a breadcrumb on a category page causes items that are within the selected category to be returned without reference to a search query or criterion.

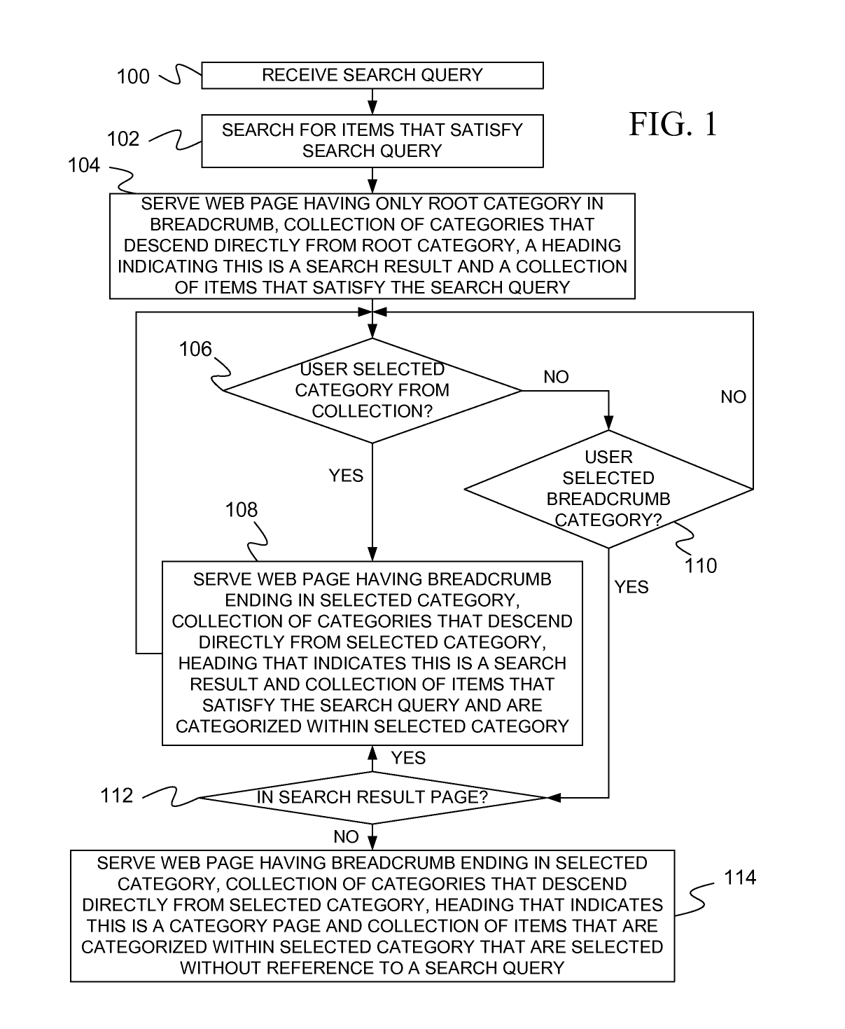

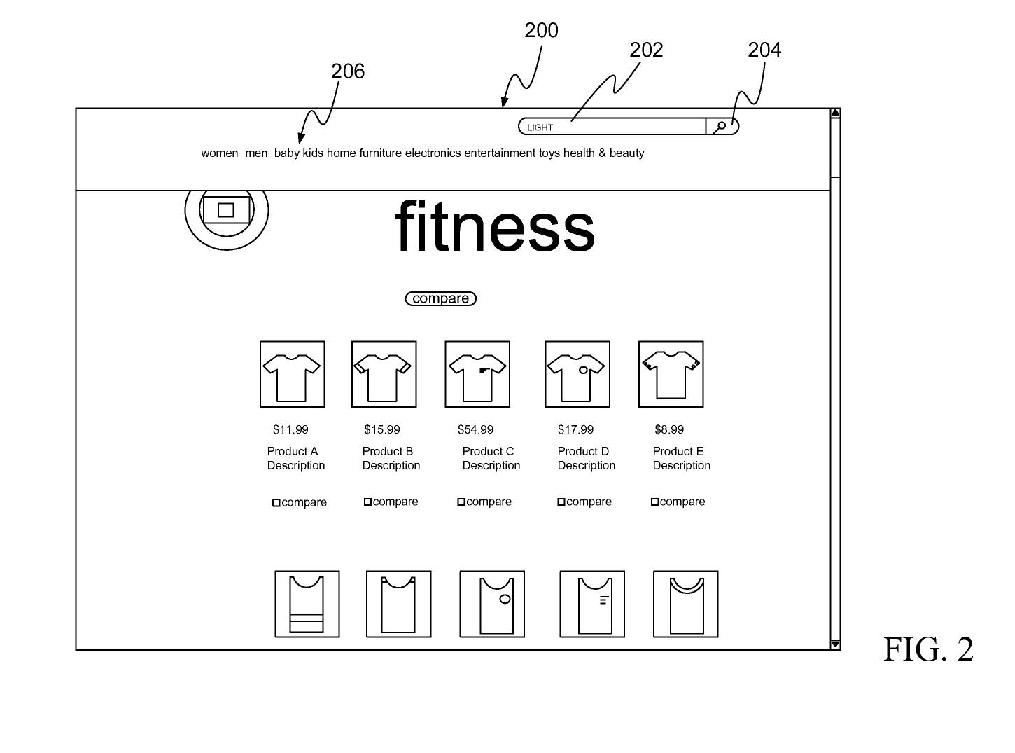

FIG. 1 provides a flow diagram of a method in accordance with one embodiment. In FIG. 1, a search query is received at step 100. Such a search query can be received through a web page such as web page 200 of FIG. 2. In particular, the search query may be entered in a search box 202, such as the query “light” shown in FIG. 2. The user may then press an enter key or select a search icon 204 to submit the query which is then received by a web server.

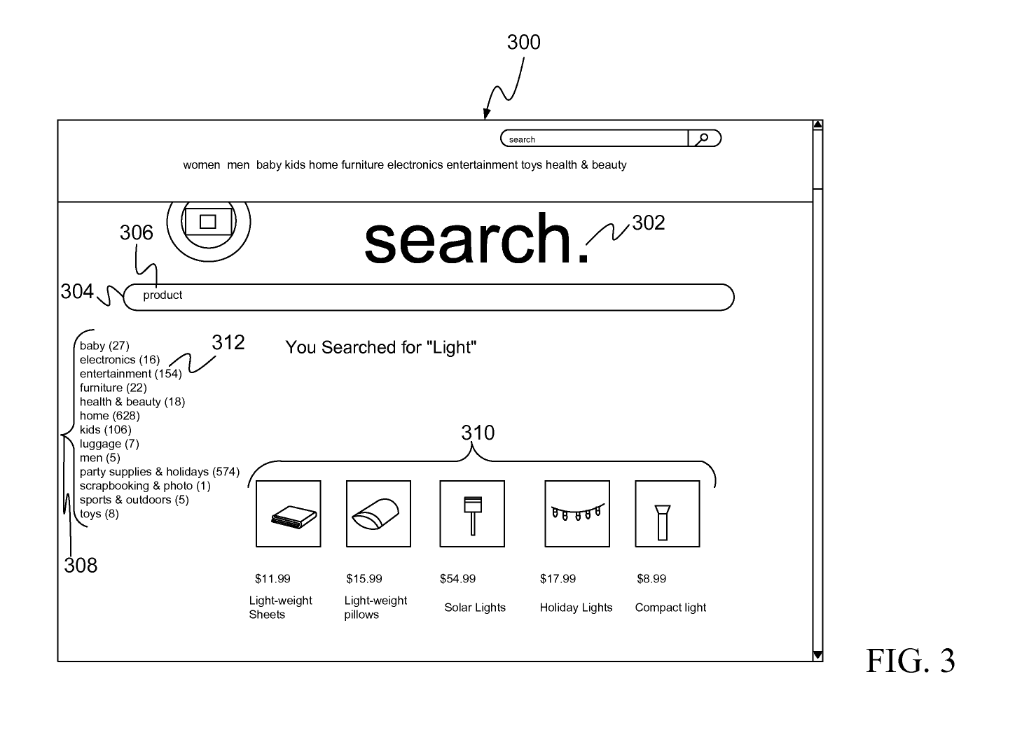

Upon receiving the search query, one or more web servers search for items that satisfy the search query at step 102. At step 104, a web server serves an initial search result web page having a heading that indicates it is a search result page and a breadcrumb consisting only of a root category. The web page also includes a collection of categories that descend directly from the root category and a collection of items that satisfy the search query at step 104. FIG. 3 provides an example web page 300 that can be displayed in step 104. Web page 300 includes search heading 302 that indicates that this web page provides results that satisfy a search query. Web page 300 also includes a breadcrumb 304 comprising a root category 306 of “products.”

Web page 300 includes a collection or list of items 310 that includes only items that satisfy the search query entered in the search box. Although only five items are shown in the collection of items, those skilled in the art will recognize that more or fewer items can be displayed depending on the search results.

Web page 300 also includes a collection of categories 308 that descend directly from the root category in a hierarchy of categories. Each category in collection of categories 308 includes a number in parenthesis that indicates the number of items in that category that satisfy the search query. For example, “entertainment” category 312 has (154) items that satisfy the search query. The collection of items 310 includes at least one item from at least two different categories in the collection of categories 308.

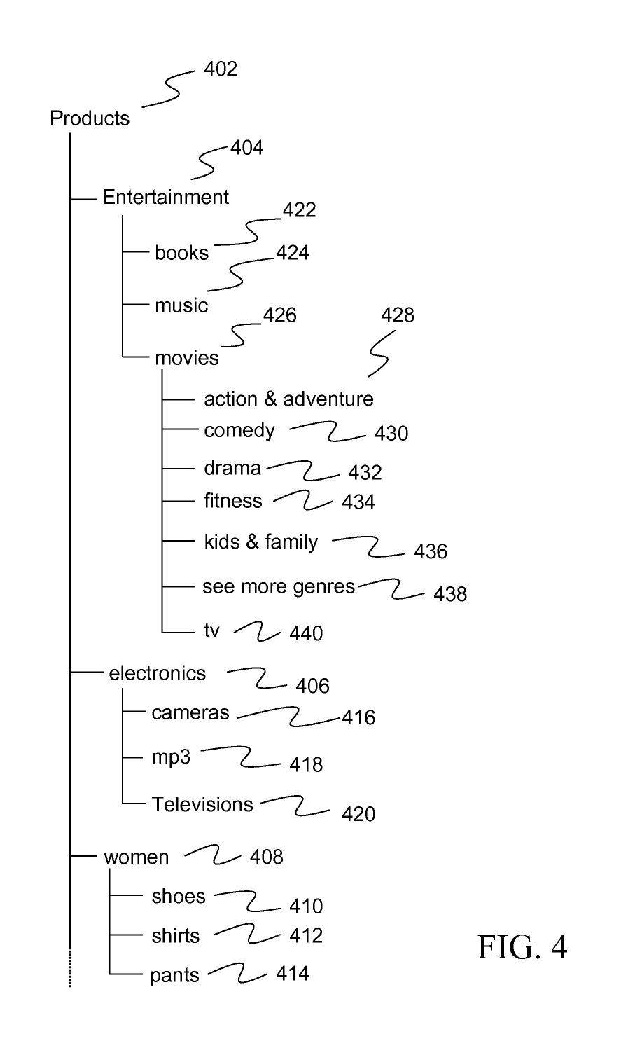

FIG. 4 provides an example of a category hierarchy 400 that forms the basis for the breadcrumbs and the collections of categories discussed herein. Those skilled in the art will recognize that category hierarchy 400 is one example of a category hierarchy and other hierarchy structures may be used.

In category hierarchy 400, there is a root category 402 of “products.” A first tier of categories descend directly from root category 402 and include “entertainment” category 404, “electronics” category 406 and “women” category 408. Additional first tier categories can descend from root category 402 but are not shown in FIG. 4. Each of first tier categories 404, 406 and 408 in turn have second tier categories that descend directly from them. For example, first tier “women” category 408 has second tier categories 410, 412 and 414. First tier “electronics” category 406 has second tier categories 416, 418 and 420. First tier “entertainment” category 404 has second tier categories that include “books” category 422, “music” category 424 and “movies” category 426.

“Movies” category 426 has third tier categories that include “action adventure” category 428, “comedy” category 430, “drama” category 432, “fitness” category 434, “kids & family” category 436, “see more genres” category 438 and “TV” category 440.

Returning to FIG. 1, if the web server receives an indication that a user has selected a category in the collection of categories 308 at step 106, the web server serves a web page having breadcrumbs ending in the selected category, a collection of categories that descend directly from the selected category, a heading that indicates that this is a search result page, and a collection of items that both satisfy the search query and are categorized within the selected category at step 108.

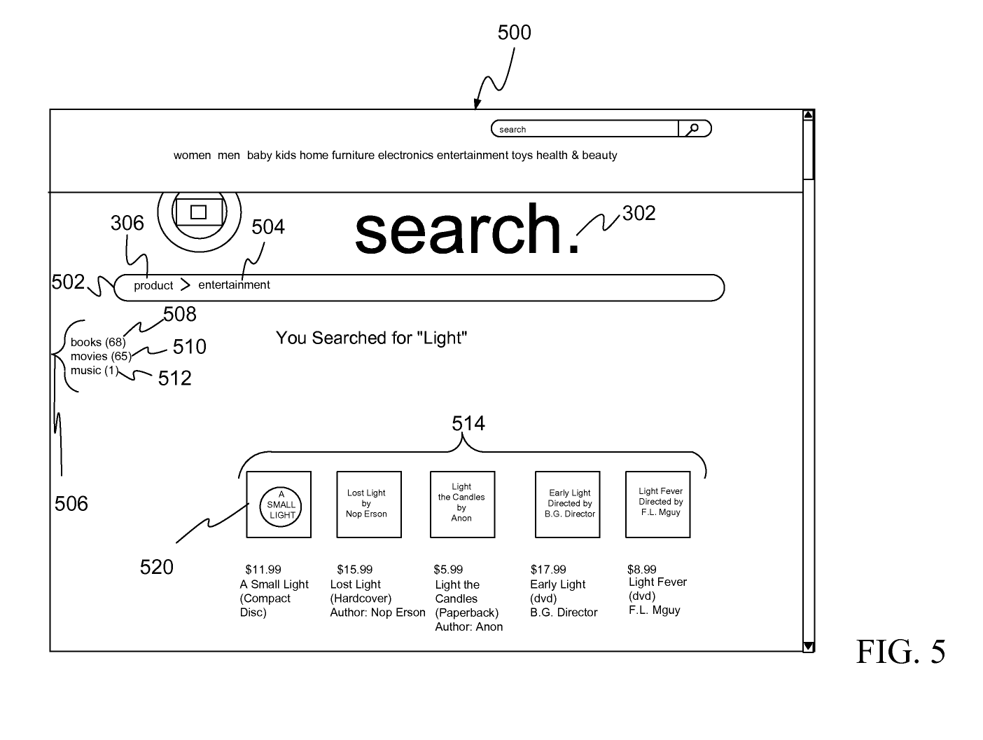

FIG. 5 provides an example of a web page that is served in step 108 when a user selects entertainment category 312 from the collection of categories 308 at step 106. Web page 500 includes search heading 302 that indicates that this web page provides items that satisfy a search query. Web page 500 also includes breadcrumb 502 that includes root category 306 and first tier “entertainment” category 504. Web page 500 also includes a collection of selectable categories 506 that are second tier descendants of first tier “entertainment” category 504 of breadcrumb 502, which is the lowest category in breadcrumb 502. Second tier descendants of first tier “entertainment” category 504 are alternatively referred to as immediate children of the lowest category in the breadcrumb. These include “books” category 508, “movies” category 510 and “music” category 512. Web page 500 also includes a collection of items 514. Each of the items in collection 514 satisfies the search criteria and also falls within “entertainment” category 504 as well as root category 306. Items 514 can include items that fall within any of the second tier categories 508, 510 and 512 of first tier “entertainment” category 504. Thus, the items could be a book, a movie or a compact disc. After step 108, the process returns to step 106 to see if the user has selected a category in the collection of categories displayed on the web page. If the user selects a new category from the collection of categories, the process returns to step 108 to serve a new web page.

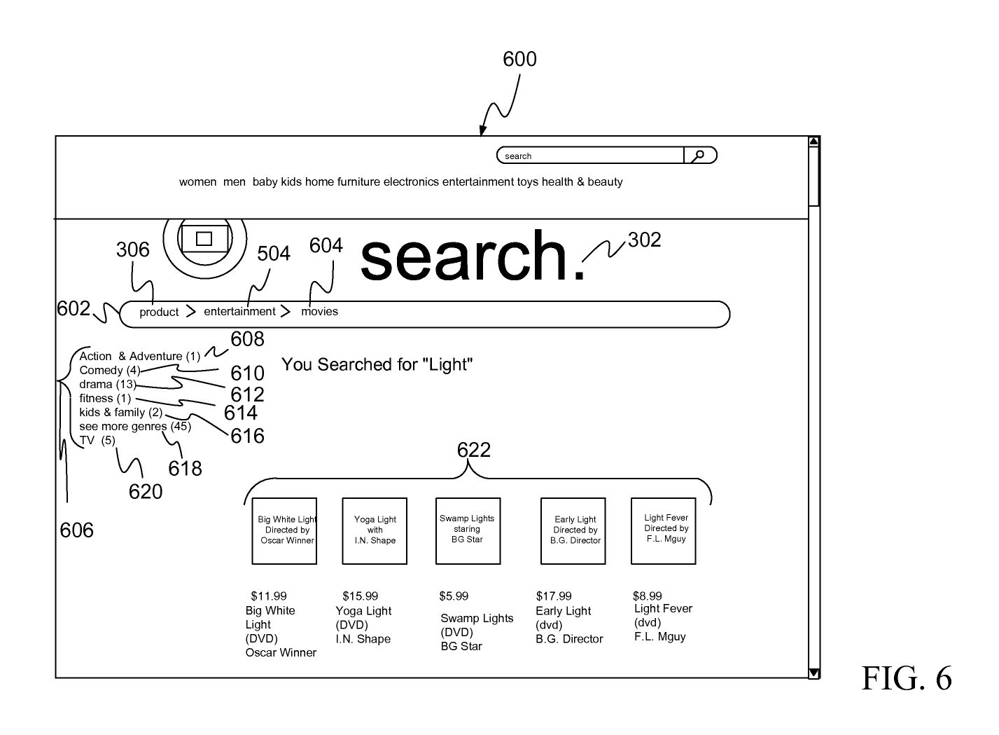

FIG. 6 provides an example of a web page 600 that is generated in step 108 after a user has selected “movies” category 510 in the collection of categories 506 of FIG. 5 at step 106. In web page 600, a heading 302 is provided that indicates that this web page provides items that satisfy a search query. Web page 600 also includes a breadcrumb 602 comprising of a chain of categories consisting of root category 306, “entertainment” category 504 and “movies” category 604. Root category 306 represents the beginning of the chain of categories and “movies” category 604 represents the end of the chain of categories.

Web page 600 also includes a collection of selectable categories 606 that are each third tier descendants or children of “movies” category 604. Collection of categories 606 includes “action & adventure” category 608, “comedy” category 610, “drama” category 612, “fitness” category 614, “kids & family” category 616, “see more genres” category 618 and “TV” category 620. Web page 600 also includes a collection of items 622, where the collection of items only includes items that are categorized within all of the categories of breadcrumb 602 including “movies” category 604, “entertainment” category 504 and products category 306. Further, the items in collection 622 must each satisfy the search criteria or query. In the example of FIG. 6, each item satisfies the search criteria for “light.”

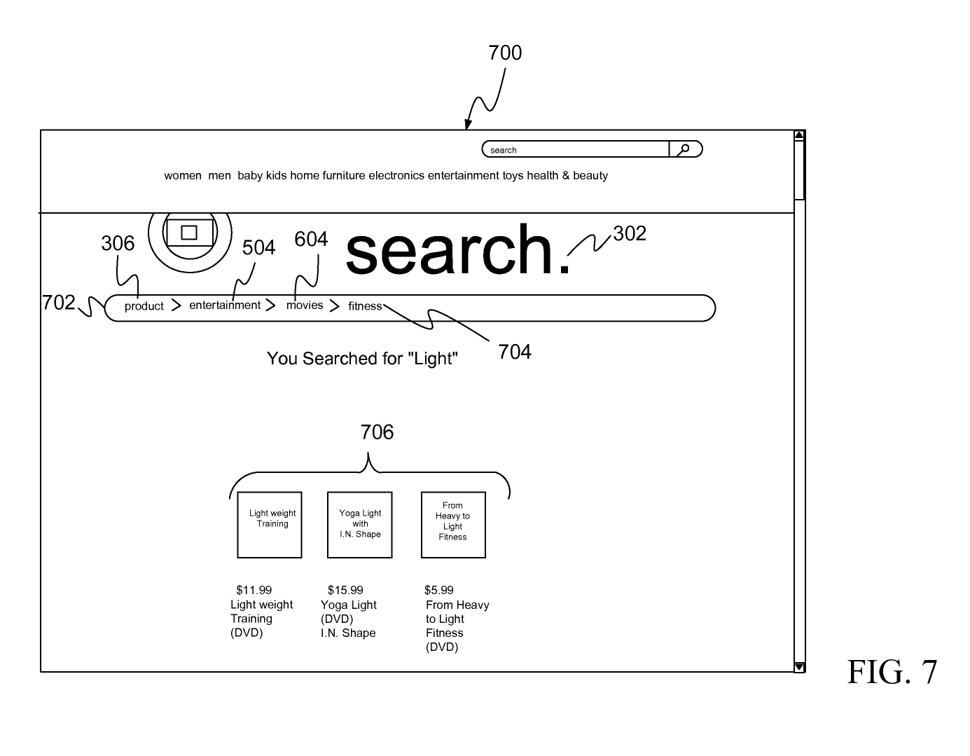

FIG. 7 provides an example of web page 700 that is displayed if a user selects “fitness” category 614 of category collection 606 at step 106. Web page 700 includes heading 302, which indicates that items displayed on this web page satisfy a search criterion or query. Web page 700 also includes breadcrumb 702 consisting of root category 306, “entertainment” category 504, “movies” category 604 and “fitness” category 704. Web page 700 does not include a collection of categories that are descendants of “fitness” category 704 because there are no fourth tier categories that are descendants of “fitness” category 704. Web page 700 also includes a collection of items 706 that are each categorized within all of the categories of breadcrumb 702 including “fitness” category 704, “movies” category 604, “entertainment” category 504 and root category 306. Further, all of the items in the collection of items 706 satisfy the search query. In particular, they satisfy the query for “light”.

In breadcrumbs 502, 602 and 702 of FIGS. 5, 6 and 7, a user is able to select any of the categories in the breadcrumb. If a web server receives an indication that a user has selected a category in a breadcrumb at step 110 of FIG. 1, the server determines if the breadcrumbs category was selected on a search result web page at step 112. A search result web page is a web page such as web pages 300, 500, 600 and 700 in which a collection of items is returned that is not only categorized within all of the categories of the respective breadcrumb but also satisfies a search criterion. If the breadcrumb category was selected from a search result web page at step 112, the process returns to step 108 and serves a web page having a modified breadcrumb ending in the selected category, showing a collection of categories that descend directly from the selected category, including a heading that indicates that this is a search result page and providing a collection of items that satisfy the search criterion and that are within the selected category. In transitioning from step 112 to step 108, the collection of items that is displayed can change and in particular items that had not been present before selecting the category in the breadcrumb may appear in the web page served at step 108 after step 112. For example, if “entertainment” category 504 is selected in either the web page of FIG. 6 or FIG. 7, the web page of FIG. 5 will be served. As shown in FIG. 5, compact disc 520, which is not present in either FIG. 6 or FIG. 7 is present in FIG. 5 because it falls within “entertainment” category 504 but does not fall within “movies” category 604 or “fitness” category 704. This occurs because a broader category has been selected and thus more items fall within the broader category while at the same time satisfying the search criterion.

If at step 112, the breadcrumb category has not been selected from a search result web page, it has been selected from a category page. Category pages may be reached by selecting first tier categories in category menu 206 and then selecting lower tier categories that are presented on the individual category pages.

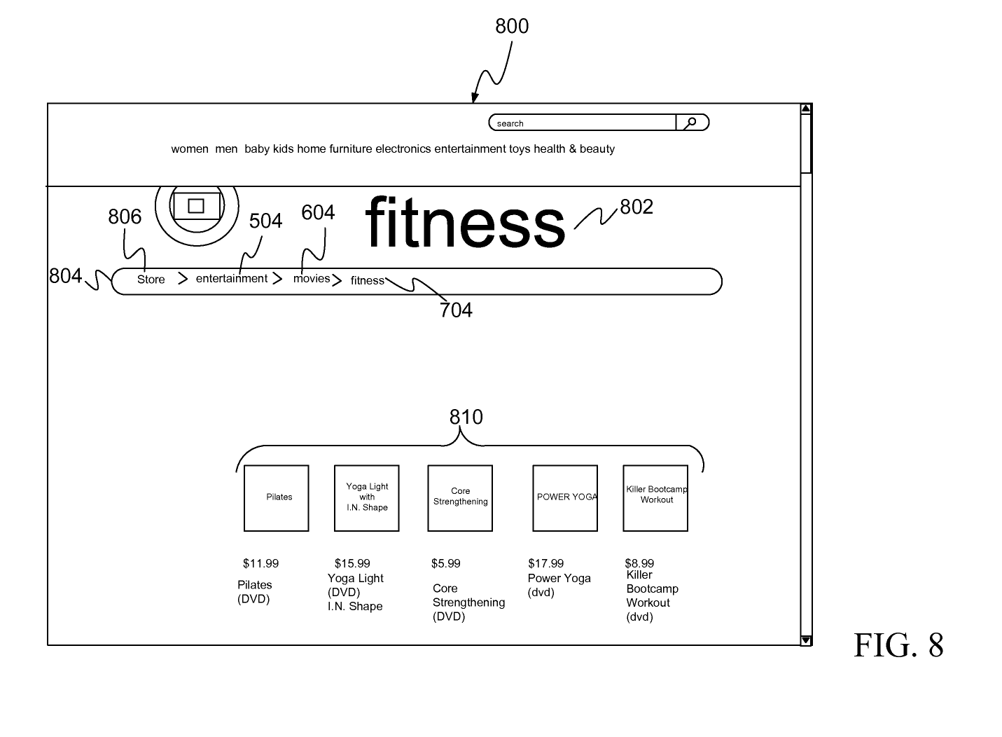

FIG. 8 provides an example of a category web page 800. Web page 800 includes a category heading 802 that indicates that this web page is for a category instead of providing search results. Web page 800 also includes a breadcrumb 804 having a root category 806, “entertainment” category 504, “movie” category 604 and “fitness” category 704. Under the embodiment of FIG. 8, heading 802 matches “fitness” category 704. Web page 800 includes a collection of items 810 that each fall within all of the categories of breadcrumb 804 including “fitness” category 704, “movies” category 604, “entertainment” category 504 and root category 806. The items in the collection of items 810 are not selected with reference to a search query or search terms entered by the user.

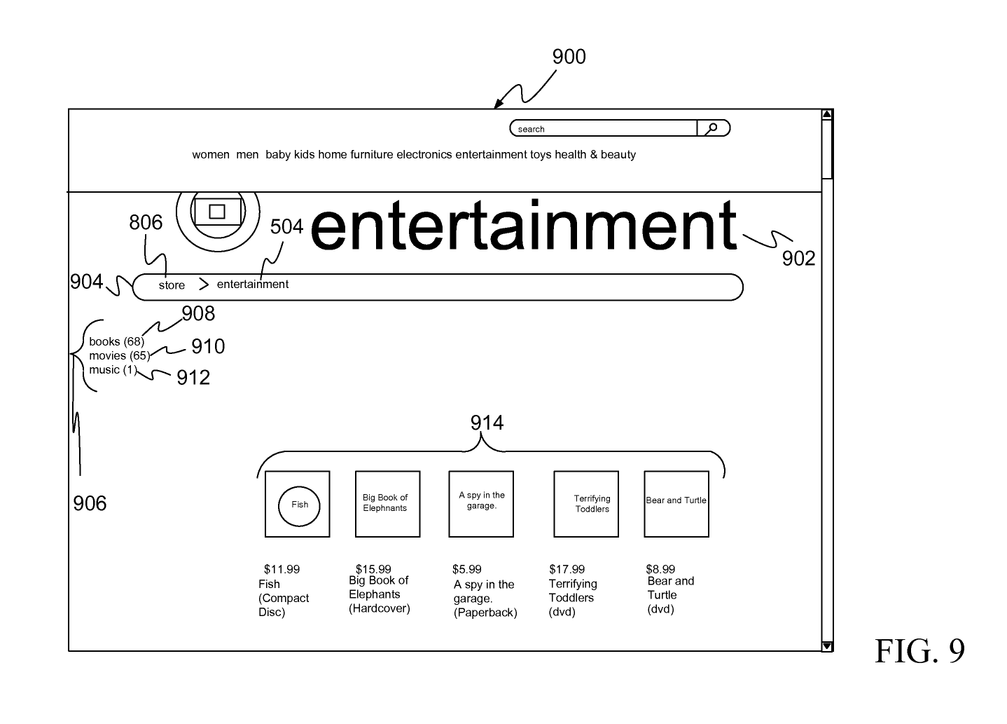

When a user selects “entertainment” category 504 of breadcrumb 804 at step 112, the process of FIG. 1 continues at step 114 where the web server serves a web page such as web page 900 of FIG. 9. Web page 900 is a category web page that includes a category heading 902 that indicates that this web page is a category page and not a search result page. Web page 900 includes a breadcrumb 904 consisting of root category 806 and “entertainment” category 504, which matches the category selected at step 110. In the embodiment of FIG. 9, category heading 902 matches selected category 504. Web page 900 also includes a collection of categories 906 consisting of “books” category 908, “movies” category 910 and “music” category 912, which are each direct descendants or children of “entertainment” category 504. Web page 900 includes a collection of items 914 that are identified and provided without reference to a search query but that each are within categories 504 and 806 of breadcrumb 904.

As can be seen from the above, the selection of the same breadcrumb category 504 produces different results depending on if the breadcrumb category is provided in the search result page or in a category page. When selected in a search result page, the returned web page will include items that not only fall within the selected breadcrumb category but that also satisfy the search criteria. However, when the same breadcrumb category is selected from a category page and not a search result page, the returned web page will include items that fall within the selected category without reference to any search criteria.

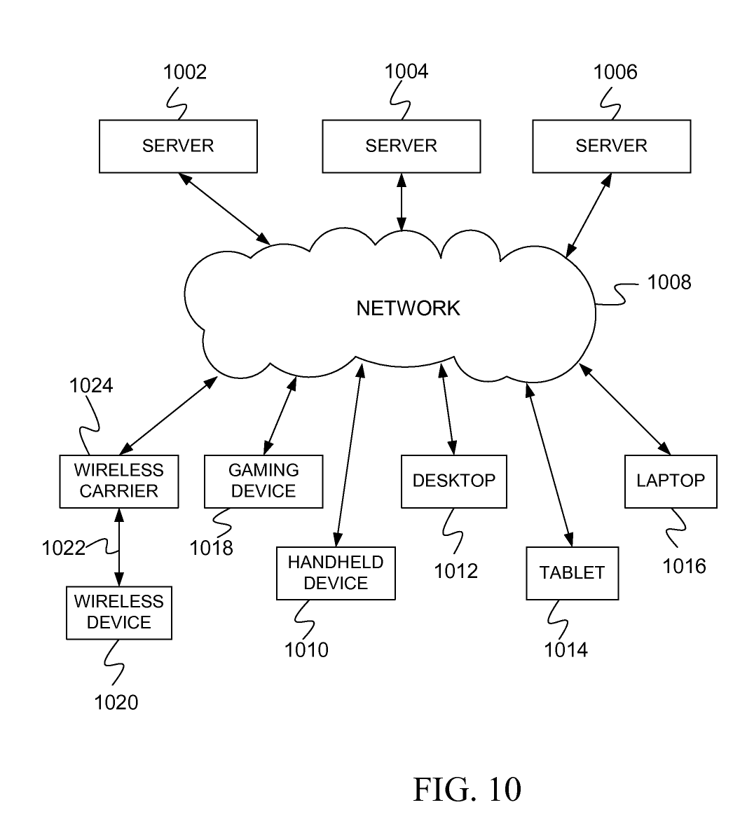

FIG. 10 provides a block diagram of a network environment which embodiments of the present invention may be practiced. In FIG. 10, a collection of servers 1002, 1004 and 1006 store one or more web pages that can be requested by client devices through a network connection 1008. Such network connections can include the Internet or other wide area networks or an intranet or other local are networks. Client devices can include, for example, handheld device 1010, desktop 1012, tablet 1014, laptop 1016, gaming device 1018 or a wireless device 1020. Wireless device 1020, including such devices as cellular phones, can request web pages through a cellular connection 1022 to a wireless carrier 1024, which is connected to the network 1008. The client devices listed for FIG. 10 are examples of available client devices and other client devices that are capable of connecting through a network 1008 to one or more servers 1002, 1004 and 1006 can be used with the present invention.

Communication along network 1008 can utilize one or more protocols including Hypertext Transfer Protocol (http), Transmission Control Protocol/Internet Protocol (TCP/IP) and the like. The web pages provided by servers 1002, 1004 and 1006 may be written in a mark-up language such as Hypertext Markup Language (HTML) or Extensible Markup Language (XML) and may utilize one or more Cascade Style Sheets. In addition, the web pages provided by servers 1002, 1004 and 1006 may use one or more scripts for rendering the page including for example JavaScript®, from Oracle Corporation.

The position of the partial logo relative to the banner may be described in terms of absolute position coordinates or relative coordinates. Further, the positioning may be set within the web page or may be determined dynamically in a script.

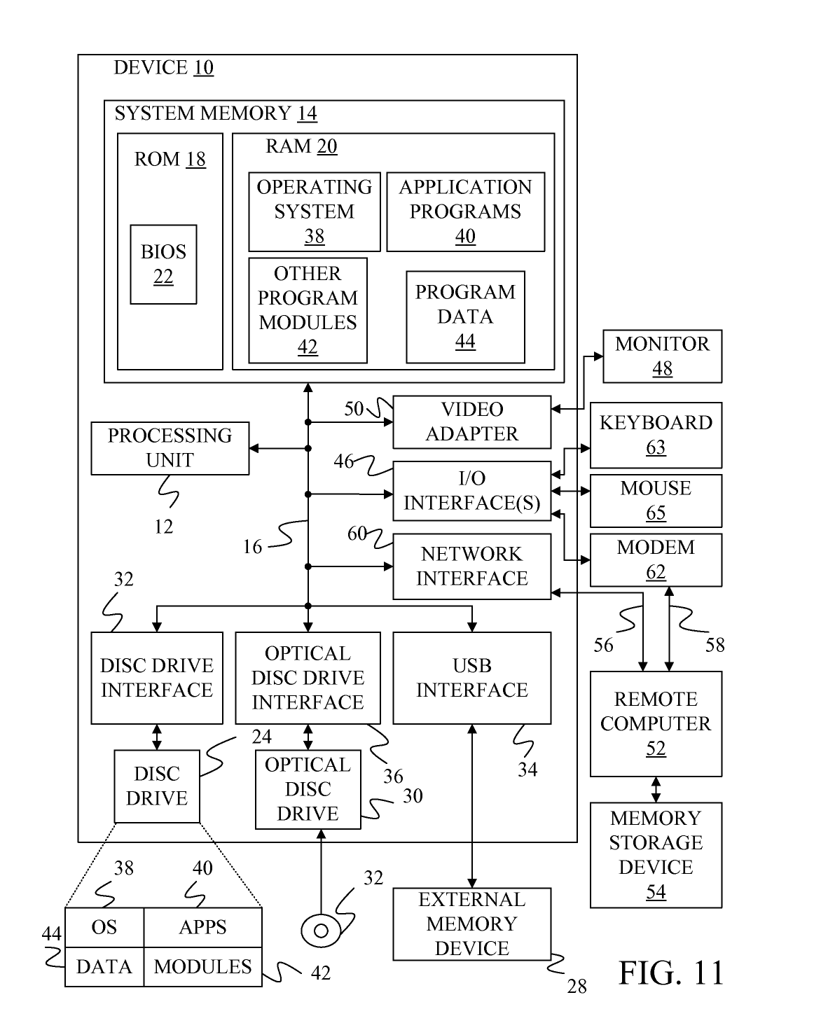

An example of a computing device that can be used as a server and/or client device in the various embodiments is shown in the block diagram of FIG. 11. The computing device 10 of FIG. 11 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the personal computer 10, is stored in ROM 18.

Embodiments of the present invention can be applied in the context of computer systems other than personal computer 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computer 10 further includes a hard disc drive 24, an external memory device 28, and an optical disc drive 30. External memory device 28 can include an external disc drive or solid state memory that may be attached to computer 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the personal computer 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include instructions for performing the steps of FIG. 1 including searching for products based on search query terms and selected categories as well as instructions for serving various web pages discussed above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The personal computer 10 may operate in a network environment utilizing connections to one or more remote computers, such as a remote computer 52. The remote computer 52 may be a server, a router, a peer device, or other common network node. Remote computer 52 may include many or all of the features and elements described in relation to personal computer 10, although only a memory storage device 54 has been illustrated in FIG. 8. The network connections depicted in FIG. 11 include a local area network (LAN) 56 and a wide area network (WAN) 58. Such network environments are commonplace in the art.

The personal computer 10 is connected to the LAN 56 through a network interface 60. The personal computer 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the personal computer 10, or portions thereof, may be stored in the remote memory storage device 54. For example, application programs may be stored utilizing memory storage device 54. In addition, data associated with an application program, such as graphical images of the products and graphics of the breadcrumbs and collections of categories may illustratively be stored within memory storage device 54. It will be appreciated that the network connections shown in FIG. 11 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer storage medium having computer executable instructions that when executed by a processor cause the processor to perform steps comprising:
displaying a first search result page comprising a plurality of items and a hierarchical list of categories, the hierarchical list of categories such that each of the plurality of items falls within all of the categories in the hierarchical list of categories, the plurality of items comprising only items that match a search criteria entered in a search box;
receiving an indication that a category in the hierarchical list of categories has been selected;
in response to the category being selected, displaying a second search result page comprising a second plurality of items that fall within the selected category, wherein the second plurality of items comprise only items that match the search criteria and wherein at least one of the second plurality of items was not displayed in the first search result page.

2. The computer storage medium of claim 1 further comprising displaying an initial search result page before displaying the first search result page, wherein the initial search result page comprises a root category, a list of first tier categories that are each immediate children of the root category, and a list of items, wherein the list of items comprises at least one item from a first category in the list of first tier categories and at least one item from a second category in the list of first tier categories.

3. The computer storage medium of claim 2 further comprising:
receiving an indication that a user has selected a category in the list of child categories;
in response to the selection of the category in the list of child categories, displaying a new search result page comprising:
a hierarchical list of categories comprising the root category and the selected category; and
a collection of items, wherein the collection of items comprise only items that fall within the selected category and that match the search criteria.

4. The computer storage medium of claim 1 wherein the hierarchical list of categories comprises a breadcrumb list.

5. The computer storage medium of claim 4 further comprising:
displaying a list of categories that are immediate children of the lowest category in the hierarchical category list;
receiving an indication that a user has selected one of the categories that are immediate children of the lowest category in the hierarchical list;
adding the selected immediate child category to the breadcrumb to form a modified breadcrumb; and
displaying a new plurality of items, each item in the new plurality of items matching the search criteria and each item in the new plurality of items falling within each of the categories in the modified breadcrumb.

6. The computer storage medium of claim 1 wherein the first search result page and the second search result page both comprise a search heading that indicates that the items in the first search result page and the second search result page are the result of a search for the search criteria.

7. The computer storage medium of claim 6 further comprising:
displaying a first category page, the category page comprising the hierarchical list of categories, items that fall within all of the categories in the hierarchical list of categories, and a heading that indicates that the first category page is a category page;
receiving an indication that a user has selected a category in the hierarchical list of categories; and
in response to the category in the hierarchical list of categories being selected, displaying a second category page comprising items that fall within the selected category, wherein at least one of the items displayed in the second category page was not displayed in the first category page, and a heading that indicates the second category page is a category page.

8. A method comprising:
receiving an indication that a guest has selected a category in a displayed breadcrumb trail, the breadcrumb trail describing a chain of categories that descend from a root category;
determining whether the displayed breadcrumb trail was displayed on a page providing results of a search query using a processor;
if the breadcrumb trail was not displayed on a page providing results of a search query, displaying items that fall within the selected category without reference to a search query; and
if the breadcrumb trail was displayed on a page providing results of a search query, displaying only items that fall within the selected category and that satisfy the search query.

9. The method of claim 8 wherein displaying only items that fall within the selected category and that satisfy the search query further comprises displaying a modified breadcrumb trail describing a chain of categories that ends with the selected category.

10. The method of claim 9 wherein displaying only items that fall within the selected category and that satisfy the search query further comprises displaying a plurality of selectable categories that are each direct descendants of the selected category.

11. The method of claim 8 wherein if the breadcrumb trail was displayed on a page providing results of a search query, displaying only items that fall within the selected category and that satisfy the search query comprises displaying at least one item that was not displayed with the breadcrumb trail.

12. The method of claim 8 wherein if the breadcrumb trail was displayed on a page providing results of a search query, displaying only items that fall within the selected category and that satisfy the search query comprises displaying the items on a page with a heading indicating that the page is a search result page.

13. The method of claim 12 if the breadcrumb trail was not displayed on a page providing results of a search query, displaying items that fall within the selected category without reference to a search query comprises displaying the items on a page with a heading separate from the breadcrumb that matches the selected category.

14. The method of claim 12 wherein the page providing results of the search query comprises the heading indicating that the page is a search result page.

15. A computing system, the computing system comprising:
a memory storing images;
a processor serving web pages to a client by:
serving a first web page to the client, the first web page comprising instructions to display a chain of categories and items that satisfy a search query and that are categorized in a lowest category in the chain of categories;
receiving a request for a second web page, wherein the request for the second web page is generated in response to the selection of a category in the chain of categories;
identifying items that satisfy the search query and that are categorized within the selected category; and
serving the second web page to the client, the second web page comprising instructions to display a chain of categories that ends with the selected category and items that satisfy the search query and that are categorized in the selected category.

16. The computing system of claim 15 wherein the items in the second web page comprise at least one item that is not in the first web page.

17. The computing system of claim 16 wherein before serving the first web page, the processor serves an initial search result page comprising instructions to display a root category and items that satisfy the search query and that are categorized in the root category.

18. The computing system of claim 17 wherein the initial search result page further comprises instructions to display a collection of categories that are each immediate descendants of the root category in a hierarchical structure of categories.

19. The computing system of claim 18 further comprising:
the processor receiving a request for a third web page, wherein the request for the third web page is generated in response to the selection of a category in the collection of categories;
identifying items that satisfy the search query and that are categorized within the category selected from the collection of categories; and
serving the third web page to the client, the third web page comprising instructions to display a chain of categories that ends with the category selected from the collection of categories and items that satisfy the search query and that are categorized in the category selected from the collection of categories.

20. The computing system of claim 15 wherein the first web page and the second web page further comprise a search heading that indicates that the displayed items are being displayed based on a search query.
